(19) United States
(12) Patent Application Publication
(10) Pub. No.: US 2025/0176737 A1
(43) Pub. Date: Jun. 5, 2025

(54) MIRROR WITH INTEGRATED NIGHT LIGHT

(71) Applicant: Progress Lighting, LLC, Greenville, SC (US)

(72) Inventors: John Linkoln Dixon, Greer, SC (US); Palmer Joseph Primm, Greenville, SC (US)

(21) Appl. No.: 18/961,901

(22) Filed: Nov. 27, 2024

Related U.S. Application Data
(60) Provisional application No. 63/604,507, filed on Nov. 30, 2023.
(60) Provisional application No. 63/617,132, filed on Jan. 3, 2024.

(51) Int. Cl. A47G 1/02; F21V 33/00; F21Y 103/10; F21Y 115/10; G06F 3/044

(52) U.S. Cl. CPC A47G 1/02; F21V 33/004; G06F 3/044; A47G 2200/08; F21Y 2103/10; F21Y 2115/10

(57) ABSTRACT

A mirror assembly including a mirror comprising a face and a reflective layer located on a rear side of the mirror, wherein the reflective layer is partitioned to have at least one touch area in a predefined location of the reflective layer and the touch area defined by the reflective layer being removed from the rear side of the mirror in a predefined shape. The mirror assembly further includes a touch controller adhered to the rear side of the mirror and comprising at least one light source, wherein the touch controller is configured to be positioned over the at least one touch area and be responsive to user touch and light emitted by the at least one source light passes through the at least one touch area such that the light is visible and usable to the user.

### CROSS-REFERENCE TO RELATED APPLICATIONS

The present application claims the benefit of U.S. Patent Application No. 63/604,507, entitled “MIRROR WITH INTEGRATED NIGHT LIGHT” filed on 30 Nov. 2023, and U.S. Patent Application No. 63/617,132, entitled “MIRROR WITH INTEGRATED NIGHT LIGHT” filed on 3 Jan. 2024, which are incorporated herein by reference in their entirety.

### FIELD

The present disclosure relates generally to mirror assemblies with capacitive touch controllers, and more specifically to lighted mirror assemblies with capacitive touch controllers with an integrated nightlight that can project light through a touch area of a mirror of the mirror assemblies.

### BACKGROUND

Mirrors are generally used in enclosed rooms in residential and commercial buildings, such that a localized source of lighting, other than the overhead lighting within the enclosed room, may be needed to adequately illuminate the person using the mirror. Mirrors that include built-in or embedded perimeter lighting may utilize one or more mechanical switches as a control device so that a user can control the “on” or “off” state of the mirror light or to adjust the intensity of the mirror light. However, mechanical switches on the mirror housing may be a source of failure resulting in maintenance and costly repairs or retirement of the mirror.

More recently, solid-state lighting devices, such as light emitting diodes (LEDs), are more commonly used as the source of built-in or embedded perimeter mirror lighting. Capacitive touch controllers may be used as the control devices for such solid-state lighting devices. Capacitive touch controllers are typically used with non-conductive surfaces, including glass. However, mirrors include a reflective layer typically on the back side of a glass or plastic outer layer. The reflective layer is typically made of a highly polished metal, such as silver and aluminum. As a result, the metal reflective layer is also an electrically conductive layer on the back side of the mirror. When capacitive touch controllers are used with mirrors, ambient electromagnetic noise can be capacitively coupled to the reflective layer and picked-up by the capacitive touch controller resulting in spurious false signals triggering a response from the capacitive touch controller. Therefore, it is desirable to electrically isolate the capacitive touch controller from the reflective layer.

Further, for mirrors that include built-in or embedded perimeter lighting, the perimeter lighting may be utilized as a night light. However, the intensity of such a night light may be too high wasting electrical energy because the entire perimeter light is illuminated.

### SUMMARY

According to a first aspect of the present disclosure, there is provided a mirror assembly comprising a mirror comprising a face and a reflective layer located on a rear side of the mirror, wherein the reflective layer is partitioned to have at least one touch area in a predefined location of the reflective layer and the touch area defined by the reflective layer being removed from the rear side of the mirror in a predefined shape. The mirror assembly further comprises a touch controller adhered to the rear side of the mirror and comprising at least one light source, wherein the touch controller is configured to be positioned over the at least one touch area and be responsive to user touch and light emitted by the at least one source light passes through the at least one touch area such that the light is visible and usable to the user.

According to a second aspect of the present disclosure, there is provided a mirror assembly comprising a mirror comprising a face and a reflective layer located on a rear side of the mirror, wherein the reflective layer is partitioned to have at least one touch area in a predefined location of the reflective layer and the touch area defined by the reflective layer being removed from the rear side of the mirror in a predefined shape. The mirror assembly further comprises a touch controller adhered to the rear side of the mirror and comprising at least one light source, wherein the touch controller is configured to be positioned over the at least one touch area and be responsive to user touch and light emitted by the at least one source light passes through the at least one touch area such that the light is visible and usable to the user. The mirror assembly further includes a frame comprises a shape that corresponds to a shape of the mirror, the frame configured to be attached to a structure, wherein the rear side of the mirror is attached to a front side of the frame.

According to a third aspect of the present disclosure, there is provided a mirror assembly comprising a mirror comprising a face and a reflective layer located on a rear side of the mirror, wherein the reflective layer is partitioned to have at least one touch area in a predefined location of the reflective layer and the touch area defined by the reflective layer being removed from the rear side of the mirror in a predefined shape. The mirror assembly further comprises a touch controller adhered to the rear side of the mirror and comprising at least one light source, wherein the touch controller is configured to be positioned over the at least one touch area and be responsive to user touch and light emitted by the at least one source light passes through the at least one touch area such that the light is visible and usable to the user. The mirror assembly further includes a frame comprises a shape that corresponds to a shape of the mirror, the frame configured to be attached to a structure, wherein the rear side of the mirror is attached to a front side of the frame and a light assembly positioned within the frame and operatively connected to the touch controller.

### BRIEF DESCRIPTION OF THE DRAWINGS

FIG. 1 shows a front perspective view of an exemplary aspect of a mirror assembly according to the present disclosure.

FIG. 2 shows a rear perspective view of the exemplary aspect of the mirror assembly of FIG. 1, illustrating an exemplary embodiment of a frame assembly of the mirror assembly.

FIG. 3 shows an exploded perspective view of the exemplary aspect of the mirror assembly of FIG. 1.

FIG. 4 shows a front elevation view of the exemplary aspect of the mirror assembly of FIG. 1, illustrating multiple touch areas located in a bottom central portion of the mirror.

FIG. 5 shows a rear elevation view of the exemplary aspect of the mirror assembly of FIG. 1.

FIG. 6 shows a cross-sectional view of the exemplary aspect of the mirror assembly of FIG. 4.

FIG. 7 shows an enlarged cross-sectional view of the mirror of FIG. 6 taken, illustrating multiple openings in a reflective layer of the mirror defining the touch areas and an exemplary embodiment of a touch controller with an embedded nightlight adhered to the rear side of the mirror over the openings.

FIG. 8 shows an enlarged view of a portion of a rear side of the mirror of FIG. 6, illustrating the touch controller removed from the rear side of the mirror revealing the multiple openings in the reflective layer of FIG. 6.

FIGS. 9-15 shows additional exemplary embodiments for the shape of the touch area of the mirror;

FIG. 16 shows an exemplary block diagram of an exemplary embodiment of a control circuit for lighting a perimeter light assembly of the mirror assembly and for lighting a nightlight;

FIG. 17 shows a front elevation view of another exemplary aspect of the mirror assembly according to the present disclosure, illustrating a vertical rectangular mirror with a single touch area located in a bottom central portion of the mirror.

FIG. 18 shows a front elevation view of another exemplary aspect of the mirror assembly according to the present disclosure, illustrating a vertical rectangular mirror with a single touch area located in a bottom corner of the mirror.

FIG. 19 shows a front elevation view of another exemplary aspect of the mirror assembly according to the present disclosure, illustrating a horizontal rectangular mirror and a single touch area located in a bottom central portion of the mirror.

FIG. 20 shows a rear elevation view of the exemplary aspect of the mirror assembly of FIG. 19.

FIG. 21 shows a front perspective view of another exemplary aspect of the mirror assembly according to the present disclosure, illustrating an oval mirror with multiple touch areas located in a bottom central portion of the mirror and an oval frame assembly.

FIG. 22 shows a front perspective view with a mirror of the exemplary aspect of the mirror assembly of FIG. 21 separated from a frame of the mirror assembly.

FIG. 23 shows an exploded perspective view of the exemplary aspect of the mirror assembly of FIG. 21.

FIG. 24 shows a front elevation view of another exemplary aspect of the mirror assembly of FIG. 21, illustrating a single touch area located in a bottom central portion of the mirror; and

FIG. 25 shows a rear elevation view of the exemplary aspect of the mirror assembly of FIG. 24.

### DETAILED DESCRIPTION

The present disclosure provides exemplary aspects of mirror assemblies that include a touch controller and perimeter lighting for mirrors of the mirror assemblies. A separate nightlight is built into or integrated into the touch controller, which is secured to the rear side of the mirror over one or more touch areas in the mirror.

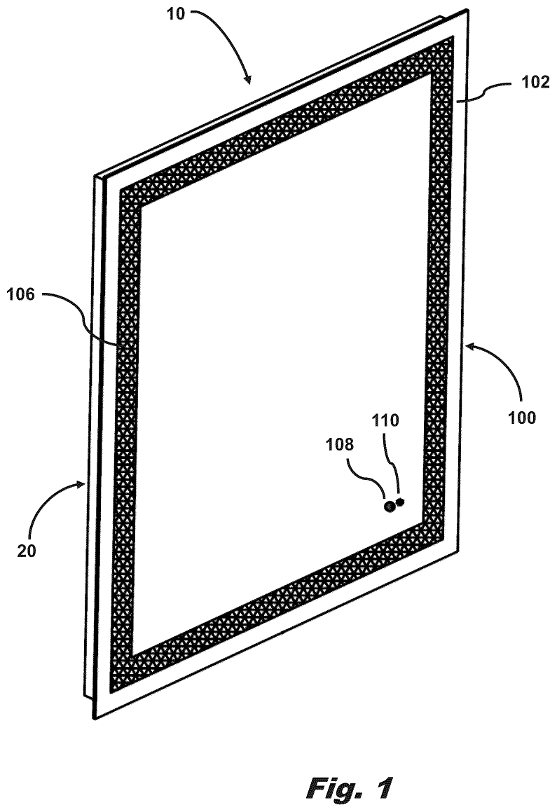

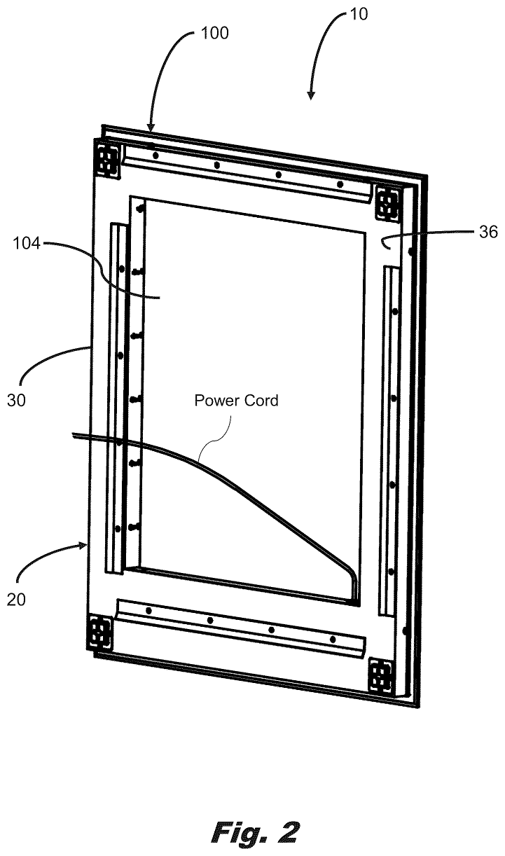

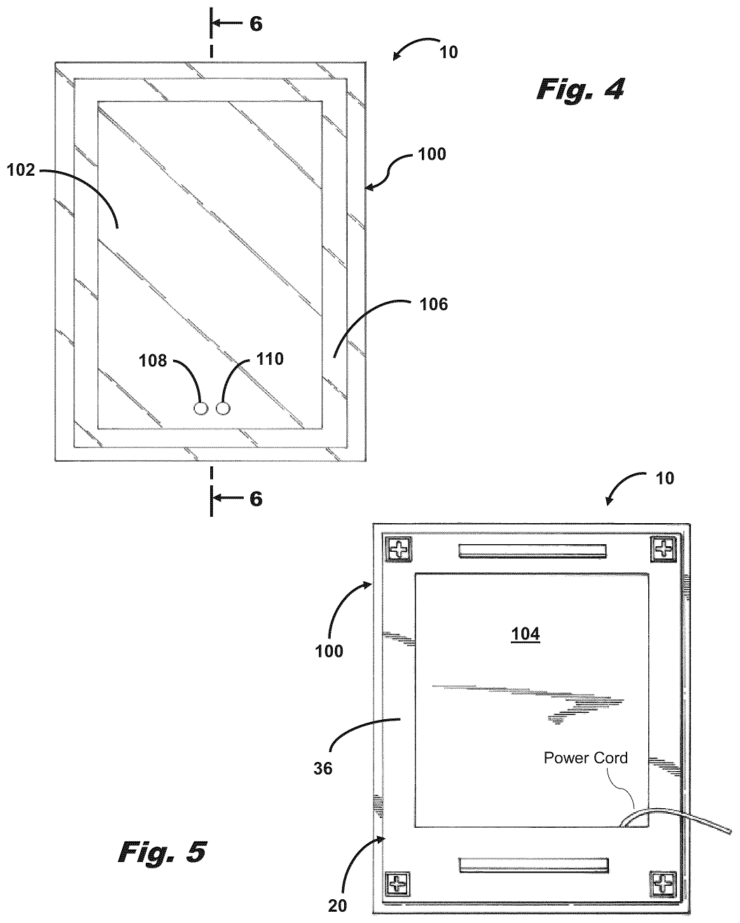

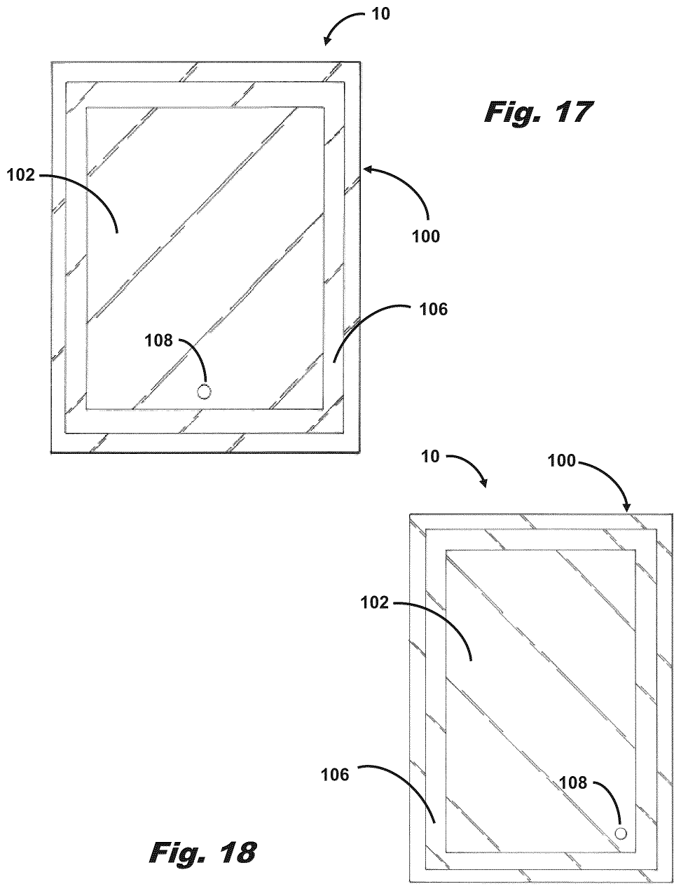

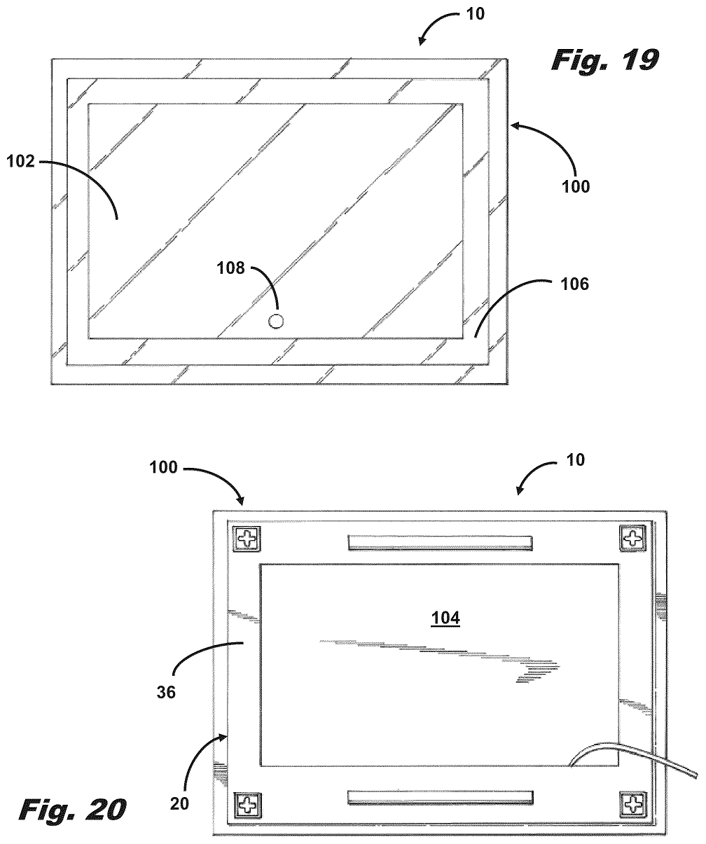

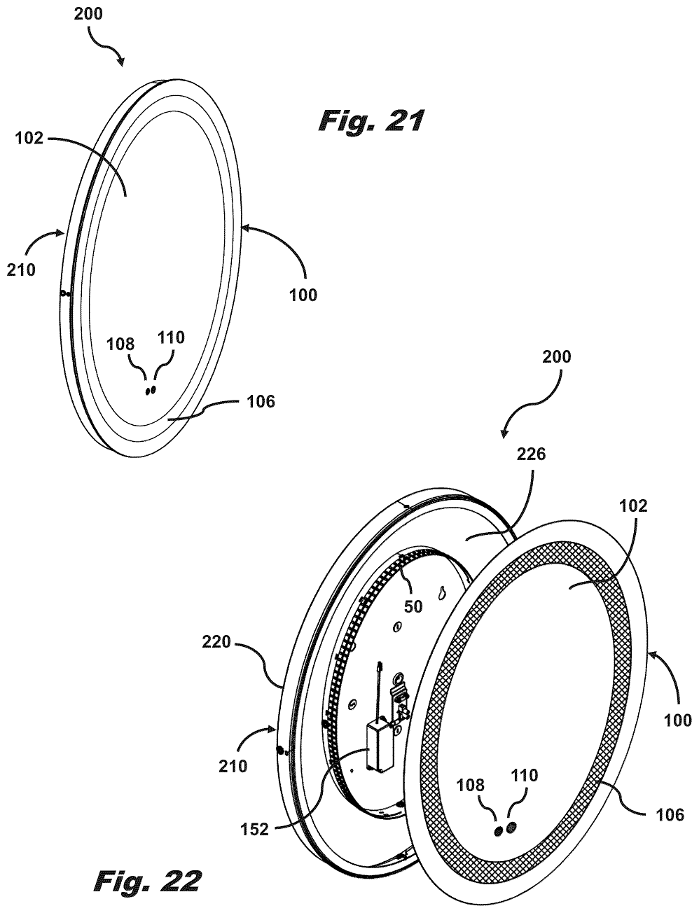

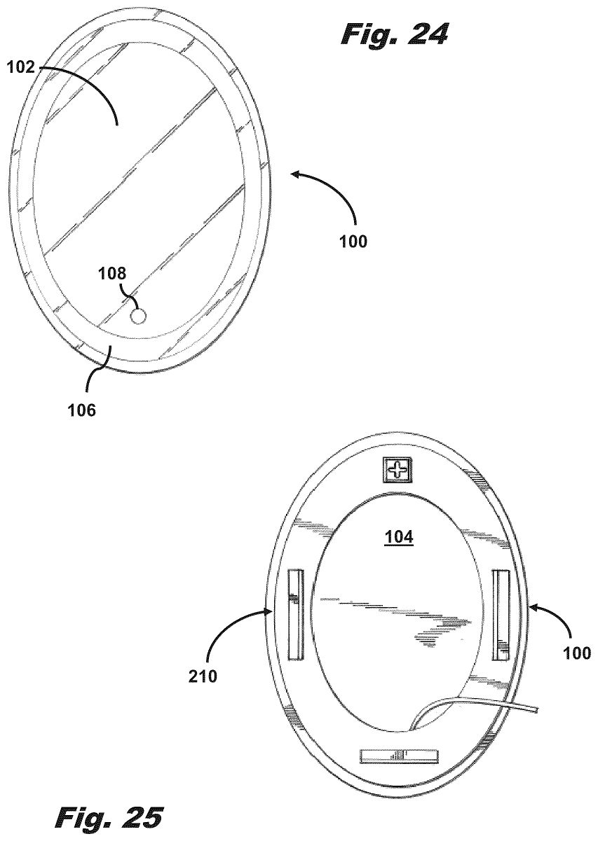

Referring now to FIGS. 1-8, an exemplary aspect of a mirror assembly 10 according to the present disclosure is shown. The primary structural components of the mirror assembly 10 includes a frame assembly 20 and a mirror 100. In the exemplary aspect of the mirror assembly shown in FIG. 1, the frame assembly 20 comprises a frame 30, a light assembly 50 and a mirror bracket 70. In some embodiments of the frame assembly 20, the frame assembly 20 can also include a seal member 90. The frame 30 is configured to support the mirror 100 and to conform to the shape of the mirror 100, such that the peripheral dimensions of the frame 30 are the same size or smaller in size as the peripheral dimensions of the mirror 100. In the aspects of the mirror assembly 10 shown in FIGS. 1-5, 17 and 18, the frame 30 is configured to support a vertically oriented rectangular mirror 100. In the aspects of the mirror assembly 10 shown in FIGS. 19 and 20, the frame 30 is configured to support a horizontally oriented rectangular mirror 100. In the aspect of the mirror assembly 10 shown in FIGS. 21-25, the frame 30 is configured to support an oval mirror 100.

In the exemplary aspect of the mirror assembly 10 shown in FIGS. 1-5, the frame 30 is configured and dimensioned as a rectangular trough having an inner wall 32 and an outer wall 34 that is spaced from the inner wall 32. A rear wall 36 is configured to extend between the inner wall 32 and the outer wall 34 forming a channel 38 of the trough. The inner wall 32, the outer wall 34 and the rear wall 36 are configured to form a frame 30 having an open central portion 35. In this exemplary aspect, the inner wall 32 can be an integrally or monolithically formed wall. In some aspects of the mirror assembly 10, the inner wall 32 can be separate wall segments, e.g., side wall segments and end wall segments, joined together by, for example, welds, adhesives and/or mechanical fasteners. In other aspects, the outer wall 34 can be an integrally or monolithically formed wall. In further aspects. the outer wall 34 can also be separate wall segments, e.g., side wall segments and end wall segments, joined together by, for example, welds, adhesives and/or mechanical fasteners. Preferably, rear wall 36 is a substantially flat wall. The channel 38 can have a uniform width around the perimeter of the frame 30, or the width or the channel 38 can vary around the perimeter of the frame 30. For example,

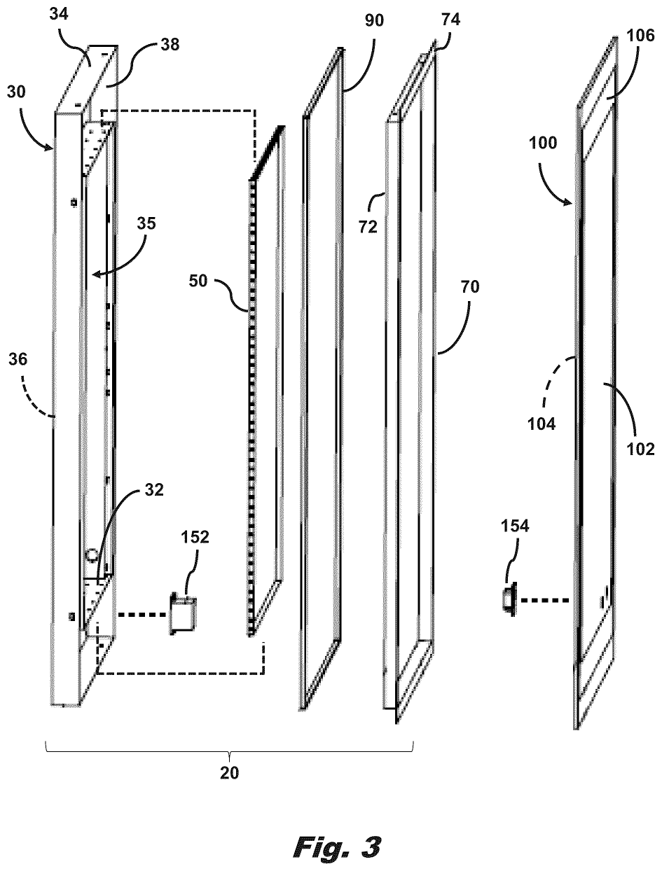

In some aspects, the width of channel 38 along the side walls of the frame 30 can be smaller than the width of channel 38 along one or both end walls of the frame 30. The light assembly 50 is positioned within the channel 38 and is electrically connected to the touch controller 154 described below. In the exemplary aspect shown in FIG. 3, the light assembly 50 is a strip of light emitting diodes, which is also known as an LED strip. The light assembly 50, e.g., the LED strip, is attached to the inner wall 32 of the frame 30 using, for example, adhesive tape and/or tie wraps. In this aspect, the mirror bracket 70 has a wall 72 and a flange 74 formed into or attached to a front edge of the mirror bracket 70 and the wall 72 is configured and dimensioned so that the wall 72 can be attached to the outer wall 34 of the frame 30. In the same aspect, the flange 74 can be used to attach the mirror bracket 70 to the mirror 100 using adhesives. In the aspect of the mirror assembly 10 that includes the seal member 90, the seal member 90 is positioned on the wall 72 of the mirror bracket 70 so that when the wall 72 is attached to the outer wall 34 of the frame 30, a seal is formed between the wall 72 and/or flange 74 of the mirror bracket 70 and the outer wall 34 of the frame 30 that limits and possibly prevents environmental conditions, e.g., moisture or liquids, from entering the channel 38 of the frame 30.

Referring to the aspect of the mirror assembly 10 of FIGS. 1-8, the mirror 100 has further includes conventional components including a face 102 and a reflective layer 104 located on a rear side of the mirror 100. The mirror can be made of glass. The reflective layer 104 can be made of a highly polished metal, such as silver and aluminum, to reflect light. The reflective layer 104 can have conductive properties, such that the reflective layer 104 can act as an antenna picking up unwanted electromagnetic energy or ambient noise that adversely affects the touch control system 150 by capacitively coupling such ambient noise to the touch control system 150. Such ambient noise if picked-up by the touch control system 150 may then appear as a false touch action creating a false signal that turns the light assembly 50 or the embedded LED 158 “on” or “off”. This potential ambient noise problem can increase as the area of the reflective layer 104 increases. The mirror 100 can also include a light emitting portion 106 extending fully or partially around a perimeter of the mirror 100. In the exemplary aspect shown, the light emitting portion 106 extends fully around a perimeter of the mirror 100, as shown in FIGS. 1 and 4. The light emitting portion 106 can be an area where the reflective layer 104 is removed from the rear side of the mirror 100 so that light within the frame 30 can be emitted through the mirror. The light emitting portion 106 can also be referred to as a lens that may include a dull polished portion of the mirror face 102 and/or can include a translucent strip (not shown) adhered to the rear side of the mirror 100 in the area where the reflective layer 104 is removed.

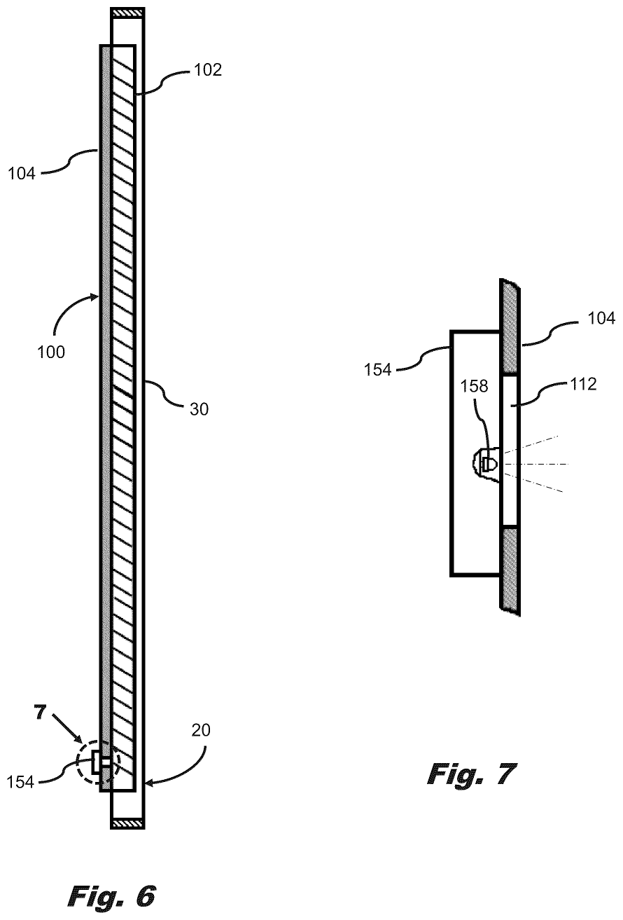

The reflective layer 104 is preferably partitioned into one or more touch areas 108 and 110. In the exemplary aspects according to the present disclosure, the one or more touch areas 108 and 110 are openings or holes 112 formed in the reflective layer 104, seen in FIG. 7, such that no reflective material is on the rear side of the mirror 100. Thus, the touch areas 108 and 110 are electrically isolated from the reflective layer 104. The opening 112 of each touch area 108 or 110 can be visible on face 102 of the mirror 100, as shown in the exemplary aspect illustrated in FIGS. 1 and 4. The dimensions of the opening 112 of each touch area 108 or 110 is configured to be sufficient such that the ambient electromagnetic noise on the reflective layer 104 does not interfere with the operation of a touch c 154 adhered to the rear side of the mirror 100, as described below.

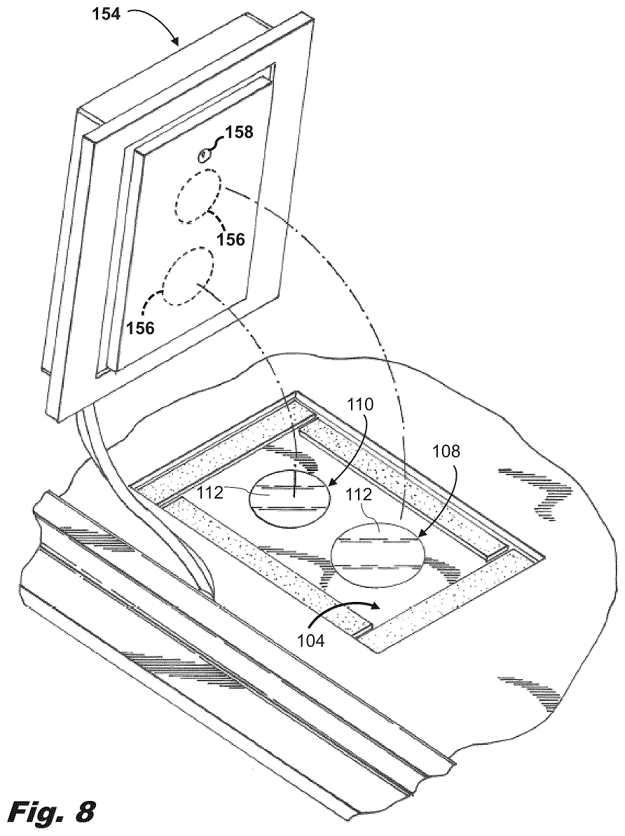

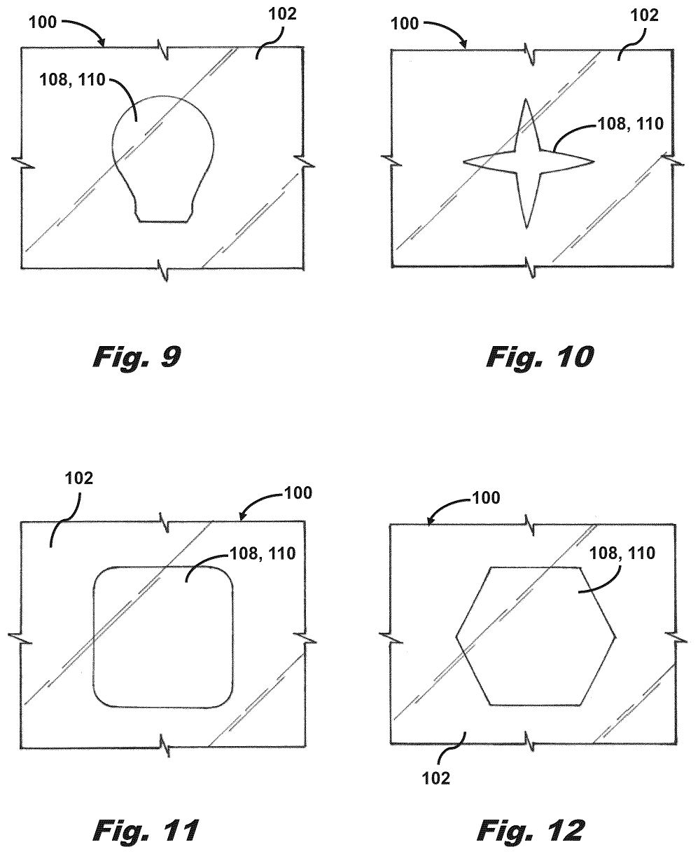

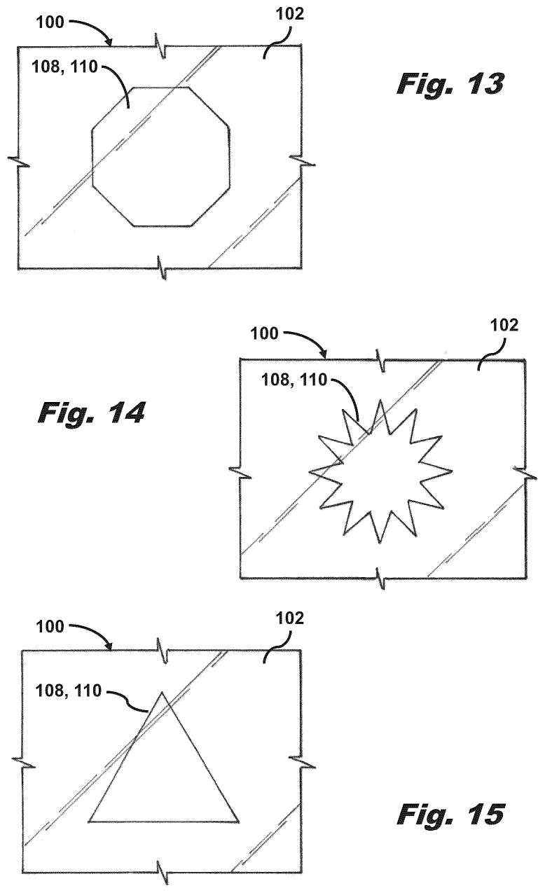

In the exemplary aspect of the mirror assembly 10 shown in FIGS. 1 and 4, the openings 112 are circular openings. The openings 112 defining each touch area 108 and 110 can have the same diameter, as shown in FIG. 4, or the openings 112 defining each touch area 108 and 110 can have different diameters, as shown in FIG. 1. For the circular openings 112, the minimum diameter of the openings 112 can be 14 mm and the maximum diameter of the openings 112 can be 22 mm such that the ambient electromagnetic noise on the reflective layer 104 does not interfere with the operation of a touch controller 154. An exemplary illustration of an implementation of a touch controller 154 that is a capacitive touch controller, model number Royoho M7025 manufactured by Shenzhen Royoho Technology Co., Ltd, Shenzhen, China, http://www.royoho.com is described. In this example, a rectangular mirror 100 has a thickness of approximately 4.8 mm, a reflective layer 104 area of approximately 36″×42″. In this example, the first circular touch area 108 would have a diameter of about 18 mm, and the second circular touch area 110 would have a diameter of about 16 mm so that ambient electromagnetic noise on the reflective layer 104 does not interfere with the operation of a touch controller 154. Further, the openings 112 can have different shapes as shown in exemplary aspect of FIGS. 9-15. The shape of the opening shown in FIG. 9 is a bulb-like shaped opening. The shape of the opening shown in FIG. 10 is a 4-point star shaped opening. The shape of the opening shown in FIG. 11 is a square-shaped opening. The shape of the opening shown in FIG. 12 is a hexagon shaped opening. The shape of the opening shown in FIG. 13 is an octagon shaped opening. The shape of the opening shown in FIG. 14 is a 12-point star shaped opening. The shape of the opening shown in FIG. 15 is a triangular shaped opening.

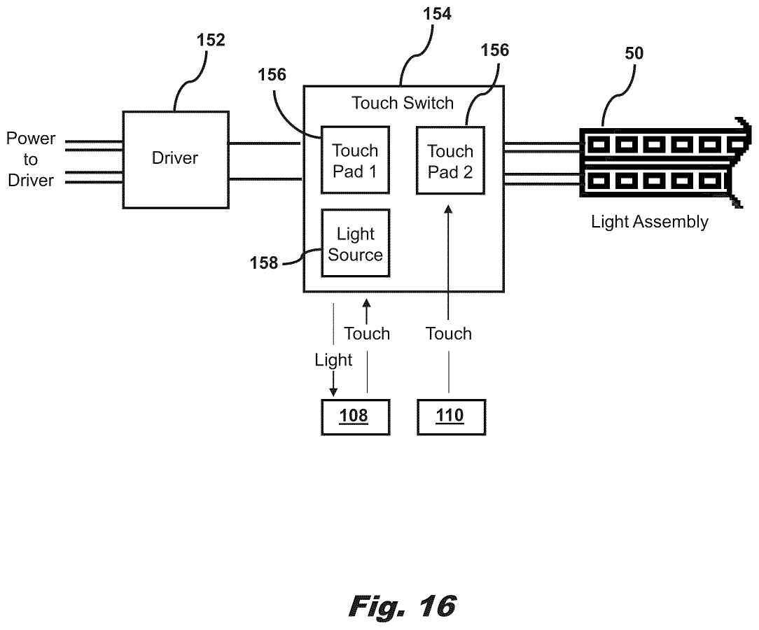

Referring now to FIG. 16, a block diagram of an exemplary embodiment of a capacitive touch control system according to the present disclosure is shown and described. The capacitive touch control system 150 includes a driver 152 and a capacitive touch controller 154. The driver 152 is configured to convert 120 v AC power to a voltage suitable for the light assembly 50 of the frame assembly 30. In the embodiment where the light assembly 50 is an LED strip, the driver 152 can be an LED driver, such as the XLG-150-12-A LED driver, manufactured by Mean Well USA, Inc. of Fremont, California, which is incorporated herein in its entirety by reference. The touch controller 154 includes one or more built-in or embedded light emitting diodes (LEDs) 158, as shown in FIGS. 7 and 16. The touch controller 154 is configured to control power from the driver 152 to the light assembly 50 and the one or more LEDs 158.

In the exemplary embodiment shown herein, the touch controller 154 is a capacitive touch controller. The capacitive touch controller 154 can have one or more built-in touch pads adjacent to the exterior surface of the capacitive touch controller 154. The capacitive touch controller 154 is positioned against the rear side of the mirror 100, as shown in FIGS. 6-8, so that touch pads 156, seen in FIG. 8, of the capacitive touch controller 154 are located over the touch areas 108 and 110 of the mirror 100. The capacitive touch controller 154 is adhered to the rear side of the mirror 100 using, for example, adhesives or adhesive strips. In this configuration, the one or more built-in or embedded LEDs 158 is also over one of the touch areas 108 or 110 of the mirror 100, such that substantially all light emitted by the one or more LEDs 158 passes through opening 112 of touch pad 108 so that the light is emitted through the face 152 of the mirror 100 and is visible and usable to the user such that the light should be enough lumens to guide a user through their home safely, but few enough lumens so that the user's sleep-wake cycle is not disrupted. As a non-limiting example, the light emitted through the face 152 of the mirror 100 is in the range from about 5 lumens to about 50 lumens. As an example, the one or more built-in or embedded LEDs 158 can be two LEDs rated at 20 lumens each, such that a total of 40 lumens of light is emitted by the two LEDs. The 40 lumens of light emitted by the two LEDs 158 is the amount of light behind the touch area 108 and/or 110 of the mirror 100 before passing through the mirror 100 and is visible and usable to a user as a low intensity night light. As is known, a portion of the light passing through the mirror 100 can be absorbed by the material forming the mirror so that the intensity of the light exiting the material can be less than the intensity of light entering the material. The light absorption rate is dependent upon the characteristics of the mirror and the properties of the material the mirror 100 is made of. As a result, in the example above, the intensity of the light exiting the mirror can be less than 40 lumens, but it would be sufficient for use as a low intensity night light. A non-limiting example of a suitable capacitive touch controller 154 is the model Royoho M7025, manufactured by Shenzhen Royoho Technology Co., Ltd, Shenzhen, China, http://www.royoho.com, which is incorporated herein in its entirety by reference.

In an exemplary aspect of the mirror assembly 10, when a user touches touch area 108 of the mirror 100, with his or her finger, the corresponding touch pad 156 of the capacitive touch controller 154 associated with the touch area 108 outputs a signal that is used by the capacitive touch controller 154 to control the light assembly 50 as follows:

### Light Control

One short press of touch area 108 causes light assembly 50 to turn “on”.
A second short press of touch area 108 causes light assembly 50 to turn “off”.
Pressing and holding the touch area 108 causes the light assembly 50 to slowly cycle from a dimming up cycle through a dimming down cycle until the user releases her or his finger from the touch area 108.
   It is noted that the LED light 158 illuminates as long as power is applied to the driver 152.

In an exemplary aspect of the mirror assembly 10, when a user touches touch area 110 of the mirror 100 with his or her finger, the touch pad 156 of the capacitive touch controller 154 associated with the touch area 110 outputs a signal that is used by the capacitive touch controller 154 to control the color temperature of the light assembly 50 as follows:

### CCT Control

One short press of the touch area 110 causes the light assembly 50 to cycle through a preset interval of two or more different color temperature levels. For example, the preset interval may be set to three, and the two or more different color temperature levels may be three color temperature levels 3000K, 4000K and 5000K. In this example, one short press of the touch area 110 would cause the light assembly 50 to cycle through three intervals of three-color temperature levels as follows: 3000K, 4000K, 5000K; 3000K, 4000K, 5000K; and 3000K, 4000K, 5000K.
Pressing and holding the touch area 110 causes the light assembly 50 to cycle continuously through all CCT values between a minimum CCT value and a maximum CCT value. Releasing the touch area 110 stops the continuous cycling of CCT values at the CCT value when the touch area is released.

Referring now to FIGS. 21-25, another exemplary aspect of a mirror assembly 200 according to the present disclosure is shown. The mirror assembly 200 includes a mirror 100 and a frame assembly 210. The mirror 100 is substantially the same as the mirrors described above, except that the shape of the mirror 100 is oval instead of rectangular. In this aspect, the mirror 100 and touch control system 150 are substantially similar as described in the exemplary aspects of the mirror assembly 10 described above.

In an exemplary aspect shown in FIGS. 21-25, the frame assembly 210 includes a frame 220, a light assembly 50 and a mirror bracket 260. The frame assembly 210 can also include a seal member 280. The light assembly 50 is substantially the same as the light assembly 50 described in the sections above. The frame 220 is configured to support the mirror 100 and to conform to the shape of the mirror 100, such that the peripheral dimensions of the frame 220 are the same size or smaller in size as the peripheral dimensions of the mirror 100. Thus, in the embodiment of FIGS. 21-25 the frame 220 is configured to support the oval mirror 100. The frame 220 is configured to include an oval trough having an inner wall 222 and an outer wall 224 that is spaced from the inner wall 222. A rear wall 226 is configured to between the inner wall 222 and the outer wall 224 forming a channel 228 of the trough. The rear wall 226 also covers the central portion of frame 220 such that the rear of the frame 220 is fully covered. In this exemplary aspect, the inner wall 222 can be an integrally or monolithically formed wall. In other aspects, the inner wall 222 can be separate wall segments, e.g., side wall segments and end wall segments, joined together by, for example, welds, adhesives and/or mechanical fasteners. In some aspects, the outer wall 224 can be an integrally or monolithically formed wall. In some aspects, the outer wall 224 can be separate wall segments, e.g., side wall segments and end wall segments, joined together by, for example, welds, adhesives and/or mechanical fasteners. In some aspects, the rear wall 226 can be a substantially flat wall. The channel 228 can have a uniform width around the perimeter of the frame 220, or the width or the channel 228 can vary around the perimeter of the frame 220. The light assembly 50 is positioned within the channel 228 and is electrically connected to the touch controller 154 described herein.

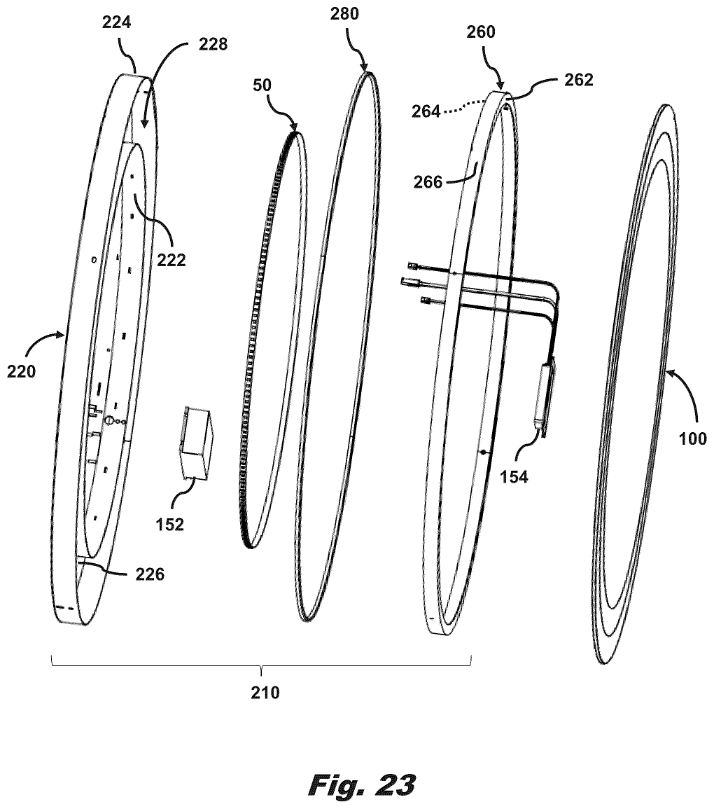

In the aspect shown in FIG. 23, the light assembly 50 is a strip of light emitting diodes, which is also known as an LED strip. The light assembly 50, e.g., the LED strip, can be attached to the inner wall 222 of the frame 220 using adhesive tape and/or tie wraps. The mirror bracket 260 can be a hollow rectangular or square shaped member having a front wall 262, a rear wall 264 and a side wall 266. The front wall 262 can be attached to a rear side of mirror 100 using adhesives. The side wall 266 is configured and dimensioned so that the side wall 266 can be attached to the outer wall 224 of the frame 220 within the channel 228. In the event the frame assembly 210 includes the seal member 280, the seal member 280 is positioned within the channel 228 so that when the mirror bracket 260 is attached to the outer wall 224 of the frame 220, a seal is formed between the rear wall 264 of the mirror bracket 70 and the outer wall 224 and the rear wall 226 of the frame 220 that limits and possibly prevents environmental conditions, e.g., moisture or liquids, from entering the channel 228 of the frame 220.

For a given capacitive touch controller 154, as the distance between the one or more built-in touch pads and the corresponding one or more touch areas 108 and 110 increases (e.g., mirrors with larger thicknesses), the size of the one or more touch pads and one or more touch areas 108 and 110 can be increased so that the capacitive touch controller 154 can detect the user's touch of the touch area 108 and/or the touch area 110. In another embodiment of the capacitive touch controller, increasing the sensitivity of the touch controller 154 can also permit the capacitive touch controller 154 to detect the user's touch of the touch area 108 and/or 110.

As noted herein, the multiple touch areas 108 and 110 are intended to permit generation of separate control signals for the light assembly 50. In the exemplary embodiments described herein, the touch area 108 can be configured for controlling the operation of the light assembly 50, and the touch area 110 can be configured for controlling the color temperature level of the light assembly 50. Thus, it can be desirable to minimize crosstalk between the built-in touch pads of the capacitive touch controller 154. The spacing between the touch pads and thus the openings 112 forming the touch areas 108 and 110 can provide capacitive isolation between the touch areas 108 and 110 and thus the touch pads limit crosstalk between the touch pads. As the distance between the tough pads and thus the touch areas 108 and 110 increases, the capacitive crosstalk between touch pads decreases. Further, increasing the spacing between the touch areas 108 and 110 can isolate the capacitive touch controller 154 from ambient electromagnetic noise that is picked up by the reflective layer 104 of the mirror.

Touch controllers 154 can be configured to perform various functions. In various embodiments, the touch controllers 154 can include a processor that receives inputs from the built-in touch pads and executes predefined functions in response thereto. A user touches one of the touch areas 108 and 110 to create a change in the capacitive circuit within the touch controller 154 that is attached to the rear side of the mirror 100 over the touch areas 108 and 110. The user's touch resulting in a change in the capacitive circuit of the touch pad 156 within the touch controller 154 which is measured by the processor. The processor then controls the operation of the light assembly 50 as described above, including, for example, turning the light assembly 50 “on” or “off”, adjusting the intensity of the light emitted by the light assembly 50, and adjusting the color temperature of the light emitted by the light assembly 50.

As shown throughout the drawings, like reference numerals designate like or corresponding parts. While exemplary embodiments of the present disclosure have been described herein and shown in the accompanying drawings, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

Certain terminology may be used in the present disclosure for ease of description and understanding. Examples include the following terminology or variations thereof: up, upward, upper, top, inner, outer, down, downward, bottom, lower, etc. These terms refer to directions in the drawings to which reference is being made and not necessarily to any actual configuration of the structure or structures in use and, as such, are not necessarily meant to be limiting.

What is claimed is:

1. A mirror assembly comprising:
a mirror comprising: a face and a reflective layer located on a rear side of the mirror, wherein:
the reflective layer is partitioned to have at least one touch area in a predefined location of the reflective layer; and
the touch area defined by the reflective layer being removed from the rear side of the mirror in a predefined shape; and
a touch controller adhered to the rear side of the mirror and comprising at least one light source, wherein:
the touch controller is configured to be positioned over the at least one touch area and be responsive to user touch; and
light emitted by the at least one source light passes through the at least one touch area such that the light is visible and usable to the user.

2. The mirror assembly according to claim 1, further comprising a frame having a shape that corresponds to a shape of the mirror and configured to be attached to a structure, wherein the rear side of the mirror is attached to a front side of the frame.

3. The mirror assembly according to claim 2, further comprising a light assembly positioned within the frame and operatively connected to the touch controller.

4. The mirror assembly according to claim 3, wherein the light assembly comprises an light emitting diode (LED) strip.

5. The mirror assembly according to claim 1, wherein the touch controller includes at least one touch pad responsive to user touch.

6. The mirror assembly according to claim 5, wherein the at least one touch pad comprises a capacitive touch pad.

7. The mirror assembly according to claim 1, wherein the at least one light built into the touch controller comprises an LED.

8. The mirror assembly according to claim 1, wherein the at least one light built into the touch controller comprises a single LED rated at 40 lumens.

9. The mirror assembly according to claim 1, wherein the at least one light built into the touch controller comprises two LEDs, wherein each of the two LEDs is rated at 20 lumens.

10. The mirror assembly according to claim 1, wherein the at least one light built disposed in the touch controller comprises at least one LED rated between 5 lumens and 50 lumens.

11. The mirror assembly according to claim 1, wherein the predefined shape is selected from a group of shapes including: a circular shape, a bulb-like shape, a 4-point star shape, a square shape, a hexagon shape, an octagon shape, a 12-point star shape and a triangular shape.

12. A mirror assembly comprising:
a mirror comprising: a face and a reflective layer located on a rear side of the mirror, wherein:
the reflective layer is partitioned to have at least one touch area in a predefined location of the reflective layer; and
the touch area defined by the reflective layer being removed from the rear side of the mirror in a predefined shape; and
a touch controller adhered to the rear side of the mirror and comprising at least one light source, wherein:
the touch controller is configured to be positioned over the at least one touch area and be responsive to user touch; and
light emitted by the at least one source light passes through the at least one touch area such that the light is visible and usable to the user;
a frame comprises a shape that corresponds to a shape of the mirror, the frame configured to be attached to a structure, wherein the rear side of the mirror is attached to a front side of the frame.

13. The mirror assembly according to claim 12, further comprising a light assembly positioned within the frame and operatively connected to the touch controller.

14. The mirror assembly according to claim 13, wherein the light assembly comprises an LED strip.

15. The mirror assembly according to claim 12, wherein the touch controller includes at least one touch pad responsive to user touch.

16. The mirror assembly according to claim 15, wherein the at least one touch pad comprises a capacitive touch pad.

17. The mirror assembly according to claim 12, wherein the at least one light built into the touch controller comprises an LED.

18. The mirror assembly according to claim 12, wherein the at least one light built into the touch controller comprises at least one LED rated for about 5 lumens to about 50 lumens.

19. The mirror assembly according to claim 12, wherein the predefined shape includes at least one of a circular shape, a bulb-like shape, a 4-point star shape, a square shape, a hexagon shape, an octagon shape, a 12-point star shape and a triangular shape.

20. A mirror assembly comprising:
a mirror comprising: a face and a reflective layer located on a rear side of the mirror, wherein:
the reflective layer is partitioned to have at least one touch area in a predefined location of the reflective layer; and
the touch area defined by the reflective layer being removed from the rear side of the mirror in a predefined shape; and
a touch controller adhered to the rear side of the mirror and comprising at least one light source, wherein:
the touch controller is configured to be positioned over the at least one touch area and be responsive to user touch; and
light emitted by the at least one source light passes through the at least one touch area such that the light is visible and usable to the user.
a frame comprises a shape that corresponds to a shape of the mirror, the frame configured to be attached to a structure, wherein the rear side of the mirror is attached to a front side of the frame; and
a light assembly positioned within the frame and operatively connected to the touch controller.
